(19) United States
(12) Patent Application Publication
(10) Pub. No.: US 2011/0249589 A1
(43) Pub. Date: Oct. 13, 2011

(54) CHANNEL SENSING SCHEME USING NATURAL QUIET PERIOD IN COGNITIVE RADIO SYSTEM

(75) Inventors: Gwangzeen Ko, Seoul (KR); Myung-Sun Song, Daejeon-city (KR); Sun-Jin You, Daejeon-city (KR); Chang-Joo Kim, Daejeon-city (KR)

(73) Assignee: ELECTRONICS AND TELECOMMUNICATIONS RESEARCH, Daejeon-city (KR)

(21) Appl. No.: 13/139,899

(22) PCT Filed: Dec. 15, 2009
(86) PCT No.: PCT/KR2009/007487

§ 371 Date: Jun. 15, 2011

(30) Foreign Application Priority Data
Dec. 16, 2008 (KR) 10-2008-0128179

(51) Int. Cl. H04W 24/00

(52) U.S. Cl. 370/252

(57) ABSTRACT

Provided is a method of sensing an operating channel by using a natural quiet period in a cognitive radio system. A requested QP is reduced by using a natural QP needed for communication that is intrinsic to a communication system, not by using a QP for cognitive radio.

### TECHNICAL FIELD

The present invention relates to a channel sensing scheme, and more particularly, to a method of sensing an operating channel by reducing a quiet period by using a natural quiet period in a system for setting an operating channel, which uses cognitive radio technology.

### BACKGROUND ART

Cognitive radio technology has been developed to efficiently use frequency bands, due to recent depletion in frequency resources. In a cognitive radio communication system, to sense the existence of an incumbent user (IU), a quiet period (QP) is additionally assigned to an operating channel that is currently being used. Since data transmission is not available during the QP, the QP is a major factor that causes deterioration in transmission performance of the cognitive radio communication system. Thus, there is a demand for a method of reducing the amount of QPs.

### DISCLOSURE OF INVENTION

### Technical Problem

The present invention provides a method of increasing a transmission rate of a cognitive radio communication system by transmitting data for a longer time by reducing a quiet period (QP) of the cognitive radio communication system.

### Technical Solution

According to the present invention, a requested QP is reduced by using a natural QP needed for communication that is intrinsic to a communication system, not by using a QP for cognitive radio.

According to an aspect of the present invention, there is provided a method of sensing a channel to determine a quiet period by a device in a network having a data transmission and receiving period and a quiet period in which an incumbent user of the channel is sensed, the method including searching for a period, in which data transmission is discontinued, within the data transmission and receiving period, sensing the searched period, and determining a length of the quiet period based on a result of the sensing.

According to another aspect of the present invention, there is provided a channel sensor in a network having a data transmission and receiving period and a quiet period, in which an incumbent user of the channel is sensed, the channel sensor including an information collector searching for a period, in which data transmission is discontinued, within the data transmission and receiving period, a channel sensor sensing the searched period, and a channel sensing information processor determining a length of the quiet period based on a result of the sensing.

### Advantageous Effects

As described above, according to the present invention, a channel is sensed using an NQP that is naturally generated in a cognitive radio communication system. When energy is detected using the NQP, the frequency of QP assignments needed for detecting a feature to determine the type of an IU may be reduced. Also, when the IU is detected during the NQP, since the IU may be detected without an additional QP, the QP needed for the channel sensing is reduced so that the transmission performance of the system may be improved.

### BRIEF DESCRIPTION OF DRAWINGS

FIG. 1 illustrates the structure of a natural quiet period (NQP) in a reservation mode radio mesh network according to an embodiment of the present invention;

FIG. 2 illustrates the structure of an NQP in a contention access mode radio mesh network according to another embodiment of the present invention;

FIG. 3 is a diagram for explaining the detailed structure of an NQP according to another embodiment of the present invention;

FIG. 4 is a block diagram of a channel sensor of each of a plurality of devices for sensing an incumbent user (IU) by using an NQP according to an embodiment of the present invention;

FIG. 5 illustrates the operation of a system for sensing an IU by using an NQP according to an embodiment of the present invention; and

FIG. 6 is a flowchart schematically showing a method of sensing an IU by using an NQP to determine a quiet period (QP) of a network according to an embodiment of the present invention.

### BEST MODE FOR CARRYING OUT THE INVENTION

According to the present invention, a requested QP is reduced by using a natural QP needed for communication that is intrinsic to a communication system, not by using a QP for cognitive radio.

According to an aspect of the present invention, there is provided a method of sensing a channel to determine a quiet period by a device in a network having a data transmission and receiving period and a quiet period in which an incumbent user of the channel is sensed, the method including searching for a period, in which data transmission is discontinued, within the data transmission and receiving period, sensing the searched period, and determining a length of the quiet period based on a result of the sensing.

According to another aspect of the present invention, there is provided a channel sensor in a network having a data transmission and receiving period and a quiet period, in which an incumbent user of the channel is sensed, the channel sensor including an information collector searching for a period, in which data transmission is discontinued, within the data transmission and receiving period, a channel sensor sensing the searched period, and a channel sensing information processor determining a length of the quiet period based on a result of the sensing.

### MODE FOR THE INVENTION

The present invention will now be described more fully with reference to the accompanying drawings, in which exemplary embodiments of the invention are shown. Like reference numerals in the drawings denote like elements. In the following description, when detailed descriptions about related functions or structures are determined to make the gist of the present invention unclear, the detailed descriptions will be omitted herein.

When a part may “include” a certain constituent element, unless specified otherwise, it may not be construed to exclude another constituent element but may be construed to further include other constituent elements. The terms such as “˜portion”, “˜unit”, “˜module”, and “˜block” stated in the specification may signify a unit to process at least one function or operation and the unit may be embodied by hardware, software, or a combination of hardware and software.

The IEEE 802.11h standard has been developed to operate a wireless local area network (WLAN) by using a radar signal and a satellite signal, as an incumbent user (IU) in a 5 GHz band by partially using cognitive radio technology. In this case, since the IU widely transmits a signal with a relatively large power, the cognitive radio technology is applied in a simple form. The IEEE 802.22 wireless rural area network (WRAN) is the first standard totally based on cognitive radio technology. Basically, the IEEE 802.22 WRAN is a system operating using a TV signal and wireless microphone (WMP) as an IU in an ultra-high frequency (UHF) band. The IEEE 802.22 WRAN system is currently being standardized. The IEEE 802.22 WRAN system is basically a standardized method of orthogonal frequency division multiple access (OFDMA)/time division duplexing (TDD). The assignment of a quiet period (QP) is performed by a function of a station that is referred to as a spectrum manager (SM). The present invention establishes the concept of a natural QP (NQP) in an ad-hoc network that has not been discussed until now and suggests a method of realizing the NQP.

The present invention relates to cognitive radio technology for sensing an IU in a particular frequency band in which the IU uses a particular frequency band that is assigned by a government, through frequency sensing, and for using the particular frequency band during a time or in a space, in which the IU does not use the particular frequency band.

The cognitive radio system periodically senses whether the IU uses the particular frequency band. For this purpose, the cognitive radio system uses two types of sensing methods. The first method is an in-band sensing method of sensing a frequency band in which the cognitive radio system operates, that is, an operating frequency. The second method is an out-band sensing method of sensing a band in which the cognitive radio system does not operate. The difference between these two methods is basically dependent on the existence of a QP. In the case of the in-band sensing method, the cognitive radio system discontinues its signal transmission in order to sense a channel at an operating frequency at which the cognitive radio system operates. This is because the signals of the cognitive radio system are mixed with signals of the IU so that it may be difficult to determine whether the signals of the IU exist, which is referred to as self-interference. In contrast, in the case of the out-band sensing method, at a frequency other than the operating frequency, when the cognitive radio system performs sensing in the middle of signal transmission, since the frequency band is different, the sensing of the signals of the IU is hardly affected.

The transmission feature of the cognitive radio system is greatly affected by the length of the QP. When the QP is long, the transmission time decreases. When the QP is short, a capability of sensing the IU deteriorates. Thus, an effective setting of the QP length is an important design factor in the cognitive radio system. The QP is a time period in which cognitive radio system devices discontinue transmission and sense a channel to detect whether an IU appears in a currently operating channel. The present invention relates to the concept of an NQP that may effectively reduce the QP. The concept of NQP basically refers to an unavoidable QP set in a process in order to protect an efficient transmission/receiving process of a communication system. For example, in a time division duplexing (TDD) system, a time period for periodically switching between transmission and receiving is inserted between transmission and receiving to simultaneously perform the transmission and receiving using a single frequency, which is referred to as a turn around time (TAT). Also, in a communication system based on time division multiple access (TDMA), when a transmitter transmits a frame, to guarantee priority transmission of data having a higher priority, transmission needs to be discontinued for a particular length of time called an “inter-frame space (IFS)” between every frame transmission cycles. The transmission discontinuation time generated while the communication system operating method is performed is defined as the NQP in the present invention. The NQP is a different concept from the general QP in the cognitive radio system, which is used to sense the IU. The NQP is a transmission discontinuation time totally due to the transmission method of a communication system for the efficiency of the communication method, regardless of a cognitive radio function. The NQP, such as, an IFS or backoff time, is a transmission discontinuation time that is frequently generated in a communication system in a mesh network.

The present invention relates to a method of allowing a technical job performed during the QP that is required in the realization of a cognitive radio technology to be performed during the NQP, or supplementing a QP assignment, for the purpose of improving a transmission rate of a cognitive radio system by reducing a conventionally needed QP. Thus, the present invention relates to the features of the NQP in a communication system, a process of collecting information about the feature, and a technical process of reducing or supplementing the QP assignment through the collection process.

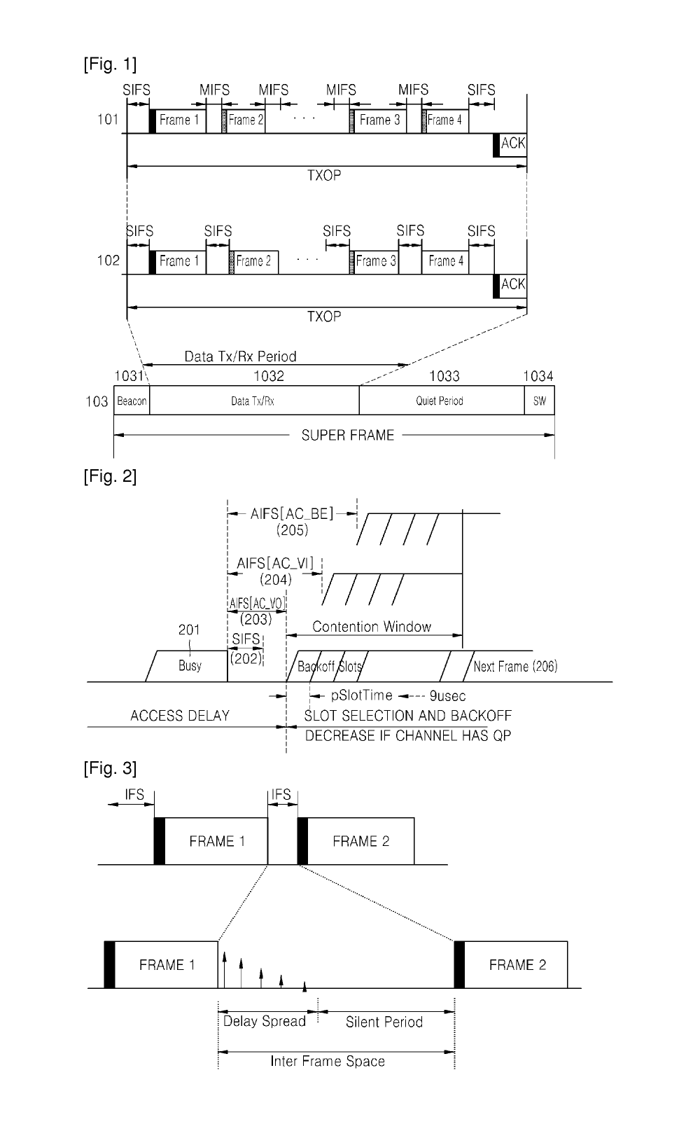

FIG. 1 illustrates the structure of an NQP in a reservation mode radio mesh network according to an embodiment of the present invention FIG. 1 illustrates an example of the NQP in a super frame structure 103 in a radio mesh network.

The super frame includes a beacon period 1031 in which a beacon is transmitted, a data transmission/receiving (Tx/Rx) period 1032 in which data is transmitted/received, a QP 1033 in which the data transmission is discontinued and an IU is sensed, and a signalling window (SW) 1034 in which a result of the IU sensing is transmitted so as to be shared by a network master or other devices. When a particular device occupies a time slot for use in the data Tx/Rx period 1032 in a reservation mode, data may be transmitted in a burst mode 101 or a regular mode 102. To check the data transmission/receiving, during the data transmission in units of frames, transmission is discontinued in the middle of frame transmission and data is transmitted after an acknowledgement ACK time interval at a receiving end, or after a minimum inter-frame spacing (MIFS) or short inter-frame spacing (SIFS), for the purpose of allowing data having a higher priority to occupy a time slot. The time interval, that is, the time in which transmission is discontinued, is the NQP that is to be used in the present invention. Since the NQP is a time period in which a device does not perform transmission, a condition for sensing an IU without a device interfering with the transmission is established. According to the present invention, the IU is sensed using the NQP.

FIG. 2 illustrates the structure of an NQP in a contention access mode radio mesh network according to another embodiment of the present invention. Referring to FIG. 2, each device performs backoff after obligatorily waiting a predetermined time such as arbitration inter-frame space (AIFS) or SIFS 202-205 according to the priority of data to be transmitted by the device after a busy period Busy 201 in which a channel is used. The waiting time is designed to solve a conflict that occurs when a plurality of devices transmit data in a contention window. Since no device can transmit data during the waiting time period, a corresponding channel may have time to sense an IU without device transmission interference. Thus, more NQPs exist in the contention access mode compared to the reservation mode. In FIG. 2, SIFS, AIFS[AC_VO], AIFS[AC_VI], and AIFS[AC_BE] periods 202-205 and the backoff period may be candidates for the NQP.

FIG. 3 is a diagram for explaining the detailed structure of an NQP according to another embodiment of the present invention. Referring to FIG. 3, the NQP in which the transmission by a device is discontinued includes a delay spread period in which a multipath interference signal transmitted from a previous frame remains, and a silent period in which the multipath interference signal does not remain. The function of the NQP is performed in the silent period. The length of the delay spread period may be easily calculated because the delay spread period is considered as a variable of maximum delay spread or coherence bandwidth during the system design.

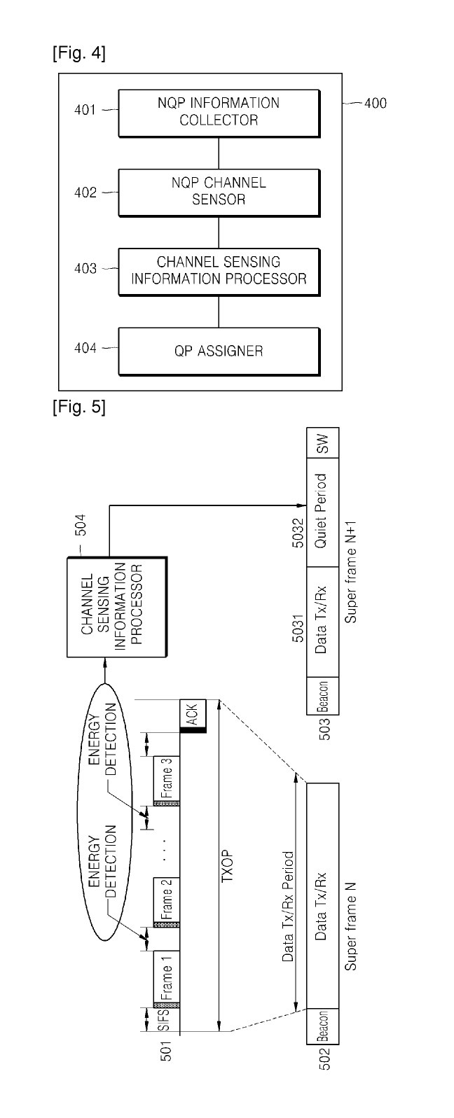

FIG. 4 is a block diagram of a channel sensor 400 of each of a plurality of devices for sensing an IU by using an NQP according to an embodiment of the present invention. Referring to FIG. 4, the channel sensor 400 includes an NQP information collector 401, an NQP channel sensor 402, a channel sensing information processor 403, and a QP assigner 404.

The NQP information collector 401 searches for a period, in which data transmission is discontinued within a data transmission/receiving period, in a network having the data transmission/receiving period and the QP in which an IU of a channel is sensed. The NQP information collector 401 collects information for determining the possibility of the existence of the NQP, for example, channel occupancy information such as a network allocation vector (NAV) in a MAC frame header, and overall super frame data assignment information, from external devices.

The NQP channel sensor 402 senses a channel during the searched period. The NQP channel sensor 402 checks for the possibility of the existence of the NQP in a corresponding super frame based on the collected information and performs energy sensing.

The channel sensing information processor 403 determines the length of the QP based on a result of the channel sensing. The channel sensing information processor 403 determines whether the IU is sensed and whether the QP is needed based on the sensing information collected by the NQP channel sensor 402 and requests an appropriate action to the QP assigner 404. The channel sensing information processor 403 may increase or decrease the length of the QP and may not assign the QP.

The QP assigner 404 assigns the QP according to the action requested by the channel sensing information processor 403.

FIG. 5 illustrates the operation of a system for sensing an IU by using an NQP according to an embodiment of the present invention. Referring to FIG. 5, a channel is sensed so as to recognize the existence of an IU by using the NQP existing during a super frame 502. The detection of energy is performed several times in the NQP (SIFS or MIFS) determined during a data transmission/receiving period 501 of the super frame 502.

Next, a result of the detection is processed by a channel sensing information processor 504 so that the assignment of the QP in a next super frame 503 may be determined. In the present embodiment, it can be seen that a QP 5032 is assigned to the super frame 503 according to a result of the process by the channel sensing information processor 504. The assigned QP may be assigned to all subsequent super frames until a new QP is assigned during the next channel sensing, or may be assigned once to a single subsequent super frame.

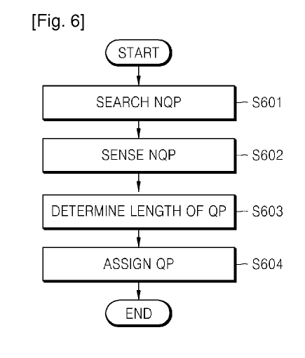

FIG. 6 is a flowchart schematically showing a method of sensing an IU by using an NQP to determine a QP of a network according to an embodiment of the present invention. Referring to FIG. 6, a channel sensor searches for the NQP in which the data transmission is discontinued, within the data transmission/receiving period (S601). The network includes the data transmission/receiving period and the QP, in which an IU of a channel is sensed, and respective devices are operated accordingly. The NQP may be an IFS in a reservation based mesh network, or the IFS and a backoff period in a contention based mesh network.

The channel sensor senses the searched NQP (S602). The energy detection may be used for searching sensing the NQP and a variety of methods including pilot detection may be used for the sensing of the IU.

The channel sensor determines whether the QP is needed and determines the length of the QP based on a result of the sensing (S603). The channel sensor assigns the QP to the subsequent frame (S604).

As described above, according to the present invention, a channel is sensed using an

NQP that is naturally generated in a cognitive radio communication system. When energy is detected using the NQP, the frequency of QP assignments needed for detecting a feature to determine the type of an IU may be reduced. Also, when the IU is detected during the NQP, since the IU may be detected without an additional QP, the QP needed for the channel sensing is reduced so that the transmission performance of the system may be improved.

In other embodiments, hardware, software, or a combination of hardware and software may be used as a computer software command to embody the present invention, instead of a programmed processor/controller. Accordingly, the present invention is not limited by a specific combination of hardware and software.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion.

In the above-described embodiment, although particular terms are used, the terms are used, without limiting the meaning thereof, only for the purpose of describing the present invention, and not for limiting the range of the present invention as defined by the accompanying claims.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of sensing a channel to determine a quiet period by a device in a network having a data transmission and receiving period and a quiet period in which an incumbent user of the channel is sensed, the method comprising:
searching for a period, in which data transmission is discontinued, within the
data transmission and receiving period;
sensing the searched period; and
determining a length of the quiet period based on a result of the sensing.

2. The method of claim 1, wherein, in a reservation based mesh network, the period in which data transmission is discontinued comprises an inter-frame space.

3. The method of claim 1, wherein, in a contention based mesh network, the period in which data transmission is discontinued comprises an inter-frame space and a backoff period.

4. The method of claim 1, wherein the sensing of the searched period comprises detecting energy from the searched period.

5. A channel sensor in a network having a data transmission and receiving period and a quiet period, in which an incumbent user of the channel is sensed, the channel sensor comprising:
an information collector searching for a period, in which data transmission is discontinued, within the data transmission and receiving period;
a channel sensor sensing the searched period; and
a channel sensing information processor determining a length of the quiet period based on a result of the sensing.

6. The channel sensor of claim 5, wherein, in a reservation based mesh network, the period in which data transmission is discontinued comprises an inter-frame space.

7. The channel sensor of claim 5, wherein, in a contention based mesh network, the period in which data transmission is discontinued comprises an inter-frame space and a backoff period.

8. The channel sensor of claim 5, wherein the sensing of the searched period comprises detecting energy from the searched period.
